(19) United States
(12) Patent Application Publication
(10) Pub. No.: US 2007/0081157 A1
(43) Pub. Date: Apr. 12, 2007

(54) Apparatus and method for estimating filtrate contamination in a formation fluid

(75) Inventors: Sebastian Csutak, Houston, TX (US); Rocco DiFoggio, Houston, TX (US)

Correspondence Address: MADAN, MOSSMAN & SRIRAM, P.C., 2603 AUGUSTA, SUITE 700, HOUSTON, TX, 77057, US

(73) Assignee: Baker Hughes Incorporated

(21) Appl. No.: 11/592,887

(22) Filed: Nov. 3, 2006

Related U.S. Application Data
(63) Continuation-in-part of application No. 10/836,675, filed on Apr. 30, 2004, now abandoned.
(60) Provisional application No. 60/468,372, filed on May 6, 2003.

(51) Int. Cl. G01J 3/44; G01N 21/65

(52) U.S. Cl. 356/301

(57) ABSTRACT

The disclosure, in one aspect, provides a method for estimating a property of a fluid that includes: pumping an ultraviolet (UV) light into a fluid withdrawn from a formation downhole at a wavelength that produces light due to the Raman effect at wavelengths that are shorter than the substantial wavelengths of fluorescent light produced from the fluid; detecting a spectrum corresponding to the Raman effect light (“Raman spectrum”); and processing the detected Raman spectrum at one or more selected wavelengths to estimate a property of the fluid. In another aspect, the disclosure provides an apparatus that includes a laser that induces UV light at a selected wavelength into a fluid in a chamber, a detector that detects Raman scattered light at wavelengths shorter than the wavelengths of the fluorescent light scattered by the fluid, and a processor that analyzes a spectrum corresponding the Raman scattered light at a selected wavelength to estimate a property of the fluid.

### CROSS REFERENCE TO RELATED APPLICATIONS

This patent application is a continuation-in-part and claims priority from U.S. patent application Ser. No. 10/836,675, entitled “Method and Apparatus for A Tunable Diode Laser Spectrometer For Analysis of Hydrocarbon Samples,” filed on Apr. 30, 2004, which takes priority from U.S. Provisional Patent Application, Ser. No. 60/468,372, filed on May 6, 2003, and entitled “A Method and Apparatus for a Tunable Diode Laser Spectrometer for Analysis of Hydrocarbon Samples.”

### BACKGROUND OF THE DISCLOSURE

1. Field of the Disclosure

The disclosure herein relates to estimating a property of a fluid downhole.

2. Description of the Related Art

Oil wells (also referred to as “wellbores” or “boreholes” are drilled at selected locations into subsurface formations to produce hydrocarbons (oil and gas). A drilling fluid, also referred to as the “mud,” is used during drilling of the wellbores. A majority of the wellbores are drilled under over-burdened or overpressure conditions, i.e., the pressure gradient in the wellbore due to the weight of the mud column is greater than the natural pressure gradient of the formation in which the wellbore is drilled. Because of the overpressure condition, the mud penetrates into the formation surrounding the wellbore to varying depths, thereby contaminating the natural fluid contained in the formation, which fluid also is referred to herein as the “connate formation fluid” or the “connate fluid”.

To estimate or determine the type of the fluid, including oil and gas, in a formation at a particular wellbore depth or to estimate the condition of the reservoir surrounding the wellbore at the particular depth, tool, referred to as the formation evaluation tool, are used during drilling of the wellbore and after the wellbore has been drilled to obtain samples of the connate fluid for analysis. After drilling the wellbore, such tools are conveyed via a wireline or a coiled tubing. During drilling of the wellbore, such tools are disposed in a bottomhole assembly above the drill bit. To obtain a sample of a connate fluid, a probe is often used to withdraw the fluid from the formation. However, the formation fluid up to a certain depth adjacent the wellbore is contaminated with the mud or in other words it includes the mud filtrate. Therefore, to obtain a clean sample of the formation fluid, the formation fluid is withdrawn for a certain period of time before taking the sample. Various sensors have been used to estimate when the fluid being drawn is clean of an acceptable quality level, i.e., that the contamination level is acceptable. Optical sensors using laser devices have been used. The mud used for drilling the wellbores can be water based or hydrocarbon based.

The present disclosure provides apparatus and methods for estimating properties or characteristics of downhole fluids contaminated by mud filtrates including but not limited to oil-based mud filtrates.

### SUMMARY OF THE DISCLOSURE

The present disclosure provides an apparatus for estimating a property of a fluid downhole that includes an ultraviolet light (UV) source for inducing or pumping light in the fluid downhole at a wavelength that will produce at least some Raman scattered light at wavelengths shorter than the shortest wavelengths of UV-excited fluorescent light generated by the fluid; a detector that detects a spectrum of the Raman scattered light; and a processor that processes the detected spectrum to provide an estimate of a property of the fluid. The wavelength of light is inversely proportional to its energy, which equals hc/λ, where, h is Planck's constant, c is the speed of light and λ is the wavelength. The ultraviolet light source may be a laser that induces a selected monochromatic light or light in a narrow wavelength band. The laser may be a single mode or multimode laser, each of which may be tunable or have a fixed frequency and may be deployed at the surface or downhole. Gas lasers such as Ne—Cu lasers or wide band gap semiconductor laser such as GaN may be used. The detector may be a wide band detector that in one aspect may include an array of detectors, wherein each such detector is tuned to measure light energy at a selected wavelength in the Raman spectra. In one aspect, the wavelengths detected include wavelengths that correspond to components, such as olefins and esters that are present in oil-based muds and not found in fluids naturally present in the formations.

The apparatus may further include a pump that pumps the fluid from the formation into a chamber having a window that is adapted to allow the UV laser light to pass onto the fluid at a first angle and to reflect the Raman scattered light to the detector at a second angle. In one aspect, a conductive or metallic material is placed on an inside surface of the chamber (a surface that is in fluid communication with the fluid withdrawn from the formation) and that of the window to surface enhance the Raman effect. The metallic particles may be applied in the form of sprayed particles or a suitable lattice type structure that allows the UV laser light to penetrate into the fluid in the chamber and allows the light scattered due to the Raman effect to be reflected back to the detector. The estimated parameter may be the presence of a particular component found in the fluid, such as an ester, olefin or an estimate of a quantitative measure of a contamination, such as an oil-based mud, in the fluid withdrawn from the formation.

The disclosure, in another aspect, is a method for estimating a property of a fluid downhole, comprising: exposing the fluid to a selected wavelength of an ultraviolet (UV) light that will produce at least some Raman-scattered light at wavelengths that are shorter than the shortest wavelengths of the UV-excited fluorescence and thereby avoiding interference between the weak Raman signal and the strong fluorescence signal, and; detecting light at a selected wavelength that is shorter than the wavelengths of fluorescent light; and estimating a presence of oil-based mud in a formation fluid using the detected light. In another aspect, the method provides: pumping a UV light into a fluid withdrawn from a formation downhole at a wavelength that produces the Raman effect at wavelengths shorter than those of the UV-excited fluorescent light generated by the fluid; detecting a spectra corresponding the Raman effect (“Raman spectra”); and estimating a property of the fluid from the Raman spectra. The pumping of the UV light may include pumping a monochromatic UV light using a laser. Estimating a property of the fluid comprises estimating a presence of an oil-based mud in the fluid from energies in the Raman spectra associated with wavelengths that correspond to at least one of: an olefin; and (ii) an ester. The fluid withdrawn from the formation may be placed in a chamber that includes a transparent window for receiving the UV light pumped into the fluid and for reflecting light in the Raman spectra to a detector. An inside surface of the chamber and window may have a metallic material thereon for surface-enhancing the Raman effect. The processing of the detected signals may include estimating an energy corresponding to one of: (i) an ester; (ii) an olefin, (iii), an ether, and (iv) an acetal in the Raman spectra, and estimating therefrom one of (i) a property of the fluid, (ii) presence of an oil-based mud in the fluid; and (iii) a proportion of an oil-based mud in the fluid. Also, detecting the spectra may include detecting Raman scattering at a plurality of wavelengths that include wavelength of at least one component present in an oil-based mud that is not present in the connate fluid in the formation. In another aspect, the disclosure provides a method that includes: introducing a Raman sensitive water-soluble tracer in a water-based mud during drilling of a wellbore; and using Raman spectroscopy to distinguish water-based mud filtrate from native water withdrawn from a formation.

In yet another aspect, a computer-readable medium accessible to a processor for executing instructions contained in a computer program embedded in the computer-readable medium is provided, wherein the instructions comprise: instructions to activate a laser that induces UV light into a fluid withdrawn from a formation at a wavelength that produces Raman effect light at shorter wavelengths of light than the wavelengths of fluorescent light produced by the fluid; instructions to receive signals from a detector that detects light energies corresponding to wavelengths in the Raman spectra; and instructions to estimate a property of an oil-based mud using an energy level at a selected wavelength of the detected light. The computer program may further include instructions to estimate the property of the oil-based mud using energy of light that corresponds to the wavelength of one of: (i) an olefin; and (ii) an ester.

### BRIEF DESCRIPTION OF THE DRAWINGS

For detailed understanding of the present disclosure, references should be made to the following detailed description of the embodiments, taken in conjunction with the accompanying drawings, in which like elements have been given like numerals, wherein:

FIG. 1 is a schematic illustration of a tool made according to one embodiment of the disclosure conveyed in a wellbore penetrating a formation for estimating a property of the fluid obtained from the formation;

FIG. 2 is a schematic illustration of the tool of FIG. 1 placed at selected location in the wellbore for in-situ analysis of the fluid being withdrawn from the formation using Raman spectroscopy, according to one embodiment of the disclosure;

FIG. 3 is a schematic diagram showing the use of a Raman Spectrometer placed adjacent a sample chamber of the tool of FIG. 2 for estimating a property of the fluid according to one embodiment of the disclosure;

FIG. 4 is a schematic diagram of certain details of a portion of the Raman spectrometer of FIG. 3 for use downhole, according to one embodiment of the disclosure;

FIG. 5 is a schematic diagram showing a portion of a surface-enhanced Raman spectrometer for estimating a property of a fluid according to one embodiment of the disclosure; and

FIG. 6 shows an example of a Raman spectrum that may be obtained and analyzed by the Raman spectrometer for estimating a property of the fluid, according to one embodiment of the disclosure.

### DETAILED DESCRIPTION OF THE EMBODIMENTS

The embodiments herein, in one aspect, provide apparatus and methods for estimating a property of a fluid downhole. In another aspect, apparatus and methods for estimating a property of a fluid downhole using Raman spectroscopy are provided. In another aspect, apparatus and methods for estimating a property of a fluid using surface enhanced Raman spectroscopy are provided.

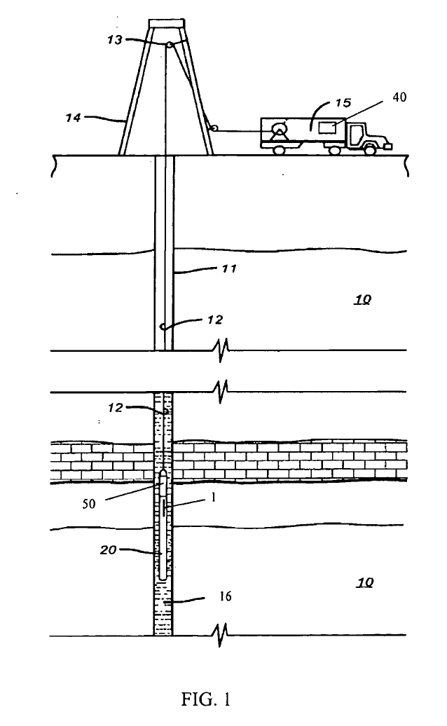

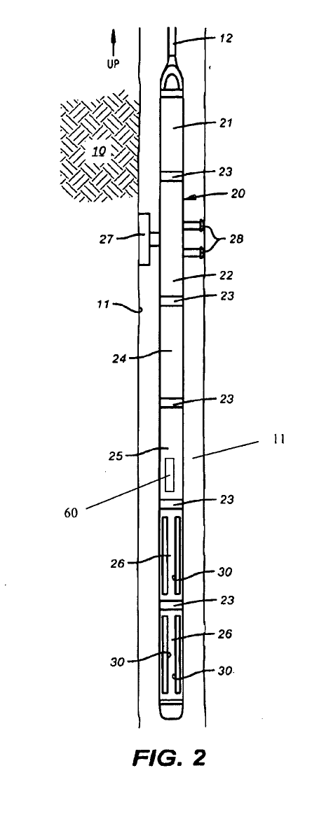

FIG. 1 is a schematic representation of a cross-section of an earth's subsurface along the length of a wellbore 11 drilled in the formation 10. Usually, the wellbore is at least partially filled with a mixture of liquids 16, including water, drilling fluid (mud) and formation fluids that are indigenous to the earth formations penetrated by the wellbore 11. The fluid mixture in the wellbore is referred to herein as the “wellbore fluid.” The term “connate fluid” or “natural fluid” herein refers to the fluid that is naturally present in the formation, exclusive of any substantial mixture or contamination by fluids not naturally present in the formation, such as the mud. Conveyed in the wellbore 11 at the bottom end of a wireline 12 is a formation evaluation tool 20 that includes an analysis module 1 made according to one embodiment of the present disclosure, as described in more detail in reference to FIGS. 2-6. The wireline 12 typically is an armored cable that carries data and power conductors for providing power to the tool 20 and a two-way data communication between the tool processor 50 and a controller 40 at a surface unit 15. The wireline 12 typically is carried from a surface unit 15 over a pulley 13 supported by a derrick 14. The surface unit 15 may be a mobile unit for on-land operations and an offshore rig for underwater operations. The controller 40 includes a processor, such as a computer or a microprocessor, data storage devices, such as solid state memory and magnetic tapes, peripherals, such as data input devices and display devices, and other circuitry for controlling and processing data received from the tool 20. The surface controller 40 also includes one or more computer programs embedded in a computer-readable medium accessible to the processor in the controller 40 for executing instructions contained in the computer programs to perform the various methods and functions associated with the processing of the data from the tool 20.

FIG. 2 illustrates in more detail one embodiment of the formation evaluation or sampling tool 20 that includes a Raman spectrometer for estimating a parameter of interest or characteristic of the fluid downhole. The sampling tool 20 is shown to be an assembly of several tool segments or modules that are joined end-to-end by threaded sleeves or mutual compression unions 23. The tool 20 includes a hydraulic power unit 21 and a formation fluid extractor 22. Below the extractor 22, a large displacement volume motor/pump unit 24 is provided for pumping fluid from the formation 10 into the wellbore 11 and/or one or more sample tanks or chambers 30. Below the large volume pump 24 is shown a similar motor/pump unit 25 having a smaller fluid displacement volume, which fluid may be quantitatively monitored using the Raman spectrometer 60. Ordinarily, one or more sample tank magazine sections 26 are assembled below the small volume pump 25. Each sample tank magazine section 26 may include one or more fluid sample tanks 30.

The formation fluid extractor 22 comprises an extensible suction probe 27 that is opposed by bore wall feet 28. Both, the suction probe 27 and the opposing feet 28 are hydraulically extensible to firmly engage the wellbore walls. Construction and operational details of fluid extraction tool 22 are more expansively described by U.S. Patent No. 5,303,775, the specification of which is incorporated herein by reference.

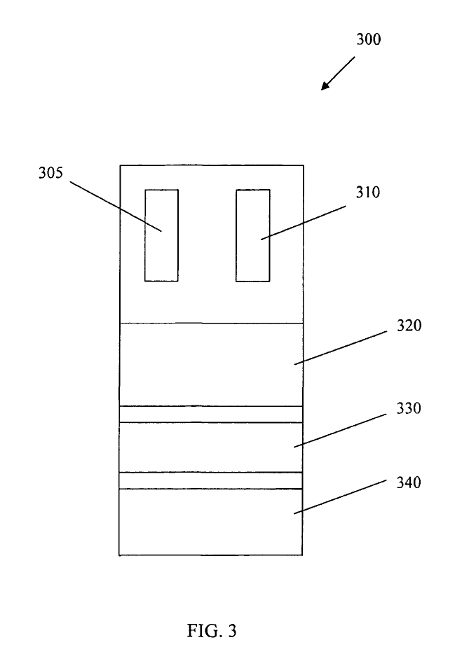

The tool 20 includes a Raman spectrometer 60 associated with the fluid withdrawn from the formation for estimating a parameter of interest or characteristic of the withdrawn fluid. The operation and function of the Raman spectrometer 60 is described in more detail in reference to FIGS. 3-6. In operation, the probe 27 and the feet 28 are extended so that the probe sealingly presses against the borehole wall. The pump 24 is used to pump the fluid from the formation via the probe 23. A portion of the fluid is passed into or through a sample chamber associated with the Raman spectrometer 60.

The Raman spectrometer 60, in one aspect, includes a tunable ultraviolet light source, such as a laser, a wideband detector and a processor. The Raman spectrometer 60, in one aspect, induces or pumps ultraviolet (UV) light at a selected wavelength or within a narrow band of wavelengths and detects energies of scattered light scattered due to the Raman effect over a wavelength spectrum and estimates therefrom a property or characteristic of the fluid, including a contamination level of the mud (also referred to herein as the mud filtrate) in the fluid being withdrawn from the formation. As noted earlier, oil-based muds are sometimes used for drilling the wellbore and therefore in such cases the formation fluid in the invaded zone contains such oil-based muds. The Raman spectrometer 60 is tuned to induce or pump the UV light at one or more selected wavelengths and to detect energies of the Raman scattered light that correspond to the wavelengths for known components in the mud, such as olefins, esters, ethers, and acetals to estimate the contamination level.

FIG. 3 shows a schematic diagram of an analysis module 300 that has an associated Raman spectrometer 305 for use in a downhole tool, such as tool 20 (FIG. 2) according to one embodiment of the disclosure. In this configuration, the Raman spectrometer 305 is placed adjacent a window 310 of a sample chamber 320 that contains the fluid withdrawn from the formation 10 (FIG. 1). The fluid may be held in the chamber 320 or it may be flowing through the chamber 320. In one aspect, the sample chamber 320 may be pressurized by high pressure gas, such as nitrogen (N2), in a chamber 330 that applies pressure on the fluid in the chamber 320. The fluid sample may be obtained using the tool 20 (FIG. 3) against hydrostatic pressure so as to maintain the fluid close to the conditions that are present in the formation. Section 330 maintains the hydrostatic pressure on the fluid. A cooling unit 340 may be provided to maintain the temperature of the various elements, such as the laser, detector and associated electronic circuitry, within a desired temperature range while the Raman spectrometer 305 is downhole. A Sorption cooling unit, a cryogenic cooling unit or any other suitable cooling system may be used for the purpose of this disclosure. A Sorption cooling unit is described in co-owned patent application Ser. No. 09/756,764, filed on Jan. 8, 2001 entitled “Downhole Sorption Cooling in Wireline Logging and Monitoring While Drilling,” which is incorporated herein by reference in its entirety. A membrane 315 in the chamber 320 may be placed to isolate vapors from the liquid. In such a configuration, the separated vapors are exposed to the incident UV light and the Raman scattered light from the vapors are then analyzed for estimating one or more properties of the fluid.

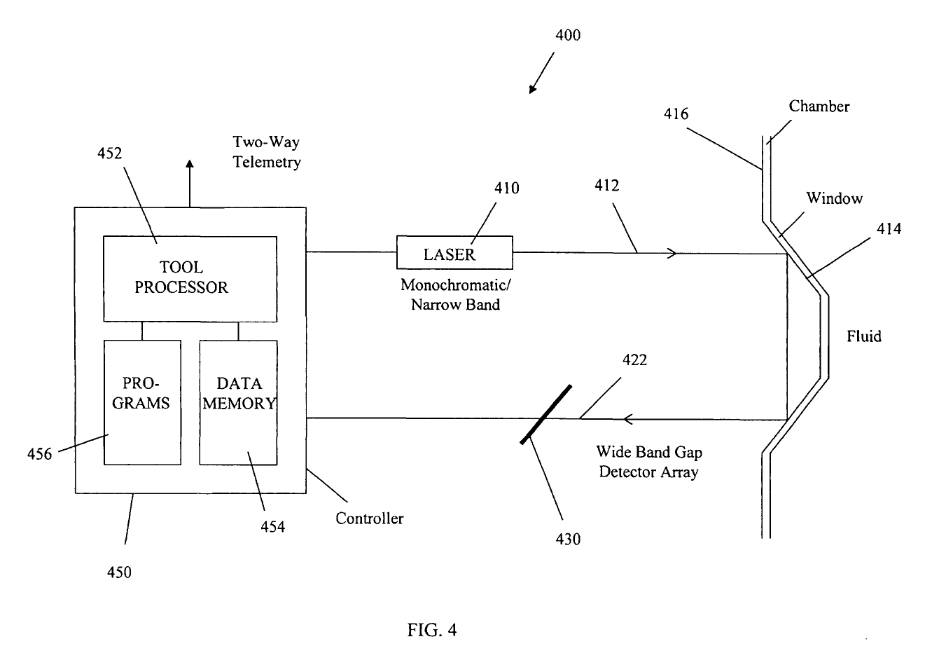

FIG. 4 is a schematic diagram illustrating certain details of the Raman spectrometer 400 for use downhole for analyzing the fluid withdrawn from the formation, according to one embodiment of the disclosure. The Raman spectrometer 400 includes a UV laser 410 that induces or pumps UV light 412 into the fluid 420 through a window 414 made into a wall of the chamber 416. The UV laser 410 may be tuned to produce UV light within a relatively narrow wavelength band. Alternatively, the UV laser 410 may be tuned to produce a monochromatic (single wavelength) UV light. The light 422 emitted by the fluid 420 is reflected back to a detector 430, which detects a selected spectrum of light and provides such spectrum to a controller 450 for analysis.

Raman spectroscopy is based on the Raman effect, which is the inelastic scattering of photons by molecules. In Raman scattering, the energies of the incident or pumped photons and the scattered photons are different. The energy of Raman scattered radiation can be less than the energy of incident radiation and have wavelengths longer than the incident photons (Stokes Lines) or the energy of the scattered radiation can be greater than the energies of the incident photons (anti-Stokes Lines) and have wavelengths shorter than the incident photons. Raman spectroscopy analyzes these Stokes and anti-Stokes lines. Thus, Raman spectroscopy makes use of an external light source and analysis of the re-emission of radiation that is shifted several nanometers or wavenumbers from the pump signal. The spectral separation between the pump and the Raman signal is specific to a given compound analyzed. Oil-based muds and natural oils present in the formation fluid have distinct Raman spectra. However, fluorescence from the fluid in the sample, which has much higher intensity, can interfere or obscure certain Raman signals. Pump lights having wavelengths about 250 nm or less provide a majority of the Raman effect for components such as olefins and esters present in the oil-based muds at wavelengths below the wavelengths at which fluorescence begins.

Thus, in one aspect, the laser 410 is tuned to produce UV light at wavelengths near or below (shorter than) 250 nm. The detector 430 may be any detector that can detect spectra of the Raman scatters corresponding to the pump light of the laser 410. In one aspect, the detector may include an array of detectors, wherein each such detector is tuned to detect light corresponding to a particular wavelength of the Raman scattered light.

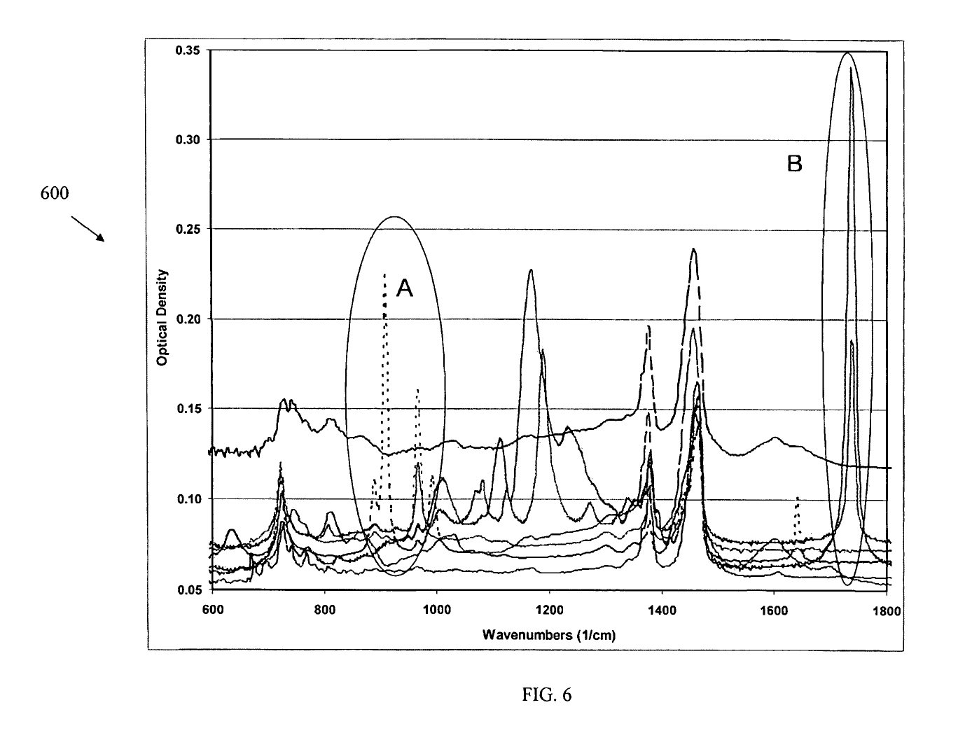

The light detected by the detector 430 passes to a controller 450. The controller may include a processor 452, memory for storing data 454 and computer programs 456. The controller 450 receives and processes the signals received from the detector 430. In one aspect, the controller 450 may analyze the detected light and transmit a spectrum of the Raman scattered light to a surface controller, such as controller 40 (FIG. 1) or estimate one or more property or characteristic of the fluid downhole and transmit such results to the controller 40. In another aspect, the controller 450 may process the signals received from the detector 430 to an extent and telemeter the processed data to the surface controller 40 for producing a spectrum, such as shown in FIG. 6, and for providing an in-situ estimate of a property of the fluid, including the contamination level of the mud in the formation fluid.

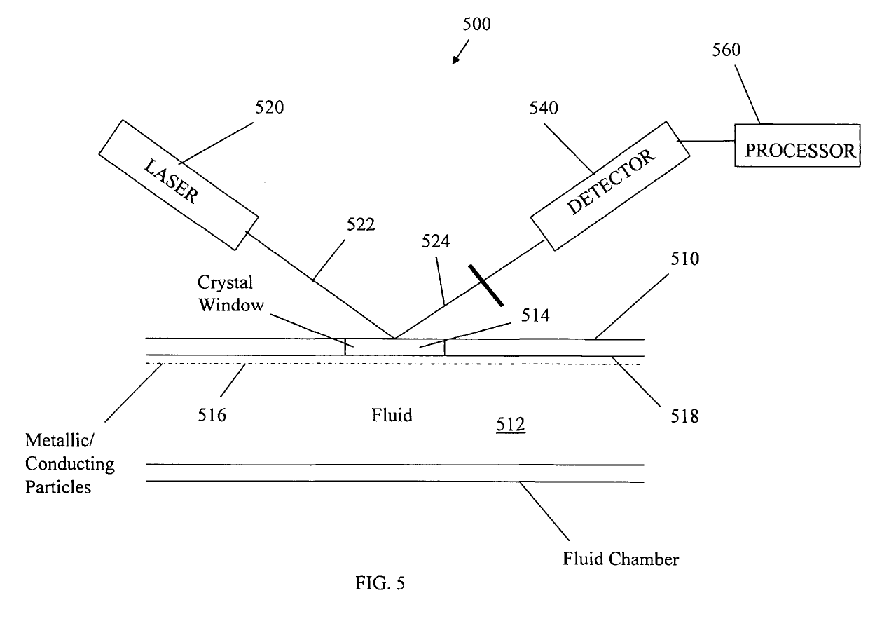

FIG. 5 is a schematic diagram showing a portion of a surface-enhanced Raman spectrometer 500 for estimating a property of a fluid according to one embodiment of the disclosure. The spectrometer 500 includes a chamber 510 for holding a fluid 512 to be analyzed. The fluid 512 may be stationary or it may be passing through the chamber 510. The chamber 510 includes a window 514 for allowing light to pass to the fluid 512. The spectrometer 500 includes a laser 520 that may be tuned to induce or pump light 522 of a desired wavelength. A controller, similar to the controller 450 (FIG. 4), controls the operation of the laser 520 and may tune the laser 520 to pump a monochromatic light UV light or UV light in a narrow waveband or it may cause the laser 520 to sweep a range of wavelengths in the UV range. The incident light 522 enters the chamber 510 through the window 514 at a selected angle. The Raman scattered light 524 from the fluid 512 leaves the window 514. A wide band detector 540, similar to the detector 430 (FIG. 4), detects the Raman spectra. A processor 560 receives the signals from the detector 540 and processes the signals to estimate a property of the fluid 512.

As noted earlier, fluorescence can interfere with the Raman signals. To increase the intensity of the Raman signal, an inside surface of the chamber 518 including the inside surface of the window 514 are coated with conductive particles 516. The conductive particles 516 may be placed in the form of scattered metallic particles, a lattice type structure, or in any other suitable form that will enhance the Raman scattered light. The conductive particles can enhance the Raman effect due to Plasmon resonance, which consists of energy exchange between the Raman signals and a surface wave that exists in a conductive layer, such as the layer of particles 516. The spectrometer 500 may be used downhole for in-situ analysis of a fluid, such as the fluid withdrawn from a formation or at the surface, to estimate one or more properties or characteristics of the fluid.

FIG. 6 shows an example of Raman spectra 600 that correspond to an incident or pump ultraviolet light of 250 nm in a fluid sample that includes oil-based mud. The spectra 600 shows the optical density along the vertical axis and the wavenumber along the horizontal axis. Olefins that are often present in oil-based muds appear around wavenumbers between 850 and 1000 as shown by the zone “A.” Esters also are often present in oil-based mud, which appear at wavenumbers above 1700 nm, as shown by the zone “B.” By monitoring the optical density in the zones “A” and “B,” estimates of the contamination level of the formation fluid due to oil-based muds can be made. Not shown are ethers, which appear at wavenumbers 1085 nm -1150 nm and acetals, which are dialkyl-ethers. In another aspect, Raman sensitive water soluble tracer(s) may be introduced into a water-based mud during drilling of a wellbore and then distinguishing natural water in the formation from water-based mud filtrate using a Raman spectrometer.

The Raman spectrometers according to the disclosure may be operated downhole for in-situ analysis of the fluid downhole. The spectrometers may be tuned at the surface to produce a monochromatic UV light or a light in a narrow band or they may be tunable while deployed downhole. The laser may be tuned to pump light at any selected wavelength or to sweep wavelengths in a range of wavelengths. The Raman spectrometers described herein, in one aspect, continuously monitor the fluid being withdrawn from a formation to provide an estimate of the contamination level of one or more parameters or characteristics of the fluid and contamination levels. Once the contamination level reaches an acceptable level, the pump 25 or 24 along with appropriate valves (not shown) may be used to divert the fluid to one or more chambers 30 (FIG. 2) for collecting formation fluid samples. The contamination level or the clean-up level may be estimated from normalized ratios of intensities of the peaks of the selected components. The spectrometers may also be used at the surface to estimate a property or content of the fluid withdrawn from subsurface formations.

While the foregoing disclosure is directed to certain embodiments that may include certain specific elements, such embodiments and elements are shown as examples and various modifications thereto apparent to those skilled in the art may be made without departing from the concepts described and claimed herein. It is intended that all variations within the scope of the appended claims be embraced by the foregoing disclosure.

What is claimed is:

1. An apparatus for estimating a property of a fluid downhole, comprising:
an ultraviolet (UV) light source for inducing light into the fluid at a wavelength that produces Raman scattered light at wavelengths that are shorter than wavelengths of substantial fluorescence reflected from the fluid in response to the induced light;
a detector that detects a spectrum of the Raman scattered light and provides signals in response to the detected spectrum; and
a processor that processes the signals to provide an estimate of the a property of the fluid.

2. The apparatus of claim 1, wherein the UV light source is a laser and the wavelength of the induced light is shorter than about 250 nm.

3. The apparatus of claim 2, wherein the detector detects the Raman scattered light at wavelengths that are shorter than the wavelengths of the fluorescence.

4. The apparatus of claim 1, wherein the UV light source is a laser that induces light that is one of: (i) a monochromatic UV light; and (ii) UV light in a narrow wavelength band.

5. The apparatus of claim 2, wherein the detector detects light at a plurality of wavelengths, including a wavelength that corresponds to one of: (i) an olefin;
(ii) an ester; (iii) an ether; and (iv) an acetal.

6. The apparatus of claim 5, wherein the property is a property of an oil-based mud.

7. The apparatus of claim 5, wherein the processor estimates a contamination level in the fluid from a measure of intensity of the signals from the detector that correspond to a wavelength of a Raman scattered light for one of: (i) an olefin; (ii) an ester; and (iii) a tracer placed in a mud supplied downhole.

8. The apparatus of claim 1, wherein the fluid downhole is contained in a chamber having a window and wherein the UV light source is disposed to pump the light in the fluid through the window.

9. The apparatus of claim 8, wherein a surface of the chamber includes conductive particles to surface enhance energy of the Raman scattered light.

10. The apparatus of claim 9, wherein the conductive particles are metallic particles and are placed on the surface as one of: (i) random particles with spaces therebetween to allow the Raman scattered light to escape the window;
and (ii) in the form of a lattice.

11. The apparatus of claim 1, wherein the UV light source produces a monochromatic light and the processor performs spectroscopy on Raman shifted light detected by the detector.

12. A method for estimating a property of a fluid, comprising:
pumping an ultraviolet (UV) light into a fluid withdrawn from a formation downhole at a wavelength that produces Raman effect at wavelengths that are shorter than wavelengths of substantial UV-excited fluorescence reflected from the fluid;
detecting a spectrum corresponding to the Raman effect (“Raman spectrum”); and
processing the detected Raman spectrum at one or more selected wavelengths to estimate the property of he fluid.

13. The method of claim 12, wherein pumping the UV light includes pumping a monochromatic UV light using a laser.

14. The method of 13, wherein estimating a property of the fluid further comprises estimating presence of an oil-based mud in the fluid from an energy in the Raman spectrum associated with a wavelength that corresponds to at least one of: (i) an olefin; (ii) an ester; (iii) an ether; and (iv) acetal.

15. The method of claim 12, wherein the fluid withdrawn from the formation is placed in a chamber that includes a window for receiving the UV light pumped into the fluid and for reflecting light in the Raman spectrum.

16. The method of claim 15, wherein an inside surface of the chamber has a metallic material thereon for surface enhancing the Raman effect.

17. The method of claim 12, wherein processing includes estimating an energy level corresponding to one of an: (i) ester; (ii) olefin; (iii) ether; and (iv) acetal, in the Raman spectrum and estimating therefrom one of (i) a property of the fluid; (ii) presence of an oil-based mud in the fluid; (iii) a contamination level in the fluid; and (iv) presence of a tracer introduced into a fluid supplied to a wellbore.

18. The method of claim 12, wherein detecting the spectrum includes detecting Raman scatters at a plurality of wavelengths that includes a wavelength of at least one component present in an oil-based mud that is not naturally present in the formation.

19. A computer-readable medium accessible to a processor for executing instructions contained in a computer program embedded in the computer-readable medium, wherein the computer program comprises:
instructions to activate a laser that induces an ultraviolet (UV) light into a fluid withdrawn from a formation at a wavelength that produces Raman scattered light that lies at wavelengths that are shorter than wavelengths of substantial UV-excited fluorescence reflected from the fluid;
instructions to receive signals from a detector that detects light corresponding to produced Raman scattered light; and
instructions to estimate a property of the fluid using an energy level at a selected wavelength of the detected light.

20. The computer-readable medium of claim 19, wherein the computer program further includes instructions to estimate a property of an oil-based mud.
